(19) United States
(12) Patent Application Publication
(10) Pub. No.: US 2022/0097489 A1
(43) Pub. Date: Mar. 31, 2022

(54) AIR VENT SYSTEM

(71) Applicant: Shanghai Yanfeng Jinqiao Automotive Trim Systems Co. Ltd., Novi, MI (US)

(72) Inventor: Yucheng TANG, Novi, MI (US)

(21) Appl. No.: 17/546,661

(22) Filed: Dec. 9, 2021

Related U.S. Application Data
(63) Continuation-in-part of application No. PCT/CN2020/094333, filed on Jun. 4, 2020.

(30) Foreign Application Priority Data
Jun. 10, 2019 (CN) 201910496260.5

(51) Int. Cl. B60H 1/34

(52) U.S. Cl. CPC B60H 1/3414; B60H 2001/3478

(57) ABSTRACT

An air vent assembly for a vehicle interior is disclosed. The assembly may comprise an inner airflow guide, an outer airflow guide and a drive mechanism comprising an inner airflow mechanism to actuate the inner airflow guide and an outer airflow mechanism to actuate the outer airflow guide. The drive mechanism when operated in a first direction will actuate the inner airflow mechanism and when operated in a second direction will actuate the outer airflow mechanism. The drive mechanism may comprise a clutch mechanism to engage the inner airflow mechanism when operated in the first direction and to engage the outer airflow mechanism when operated in the second direction. The clutch mechanism may comprise a set of one-way bearings. The inner airflow guide may comprise a vertical blade set; the outer airflow guide may comprise a horizontal blade set. The drive mechanism is operated by a motor and rotating shaft.

### CROSS-REFERENCE TO RELATED APPLICATIONS

The present application is a continuation in part of PCT/International Patent Application No. PCT/CN2020/094333 filed Jun. 4, 2020, which claims the benefit of Chinese Patent Application No. 201910496260.5 filed Jun. 10, 2019.

The present application claims priority to and incorporates by reference in full the following patent applications: (a) Chinese Patent Application No. 201910496260.5 filed Jun. 10, 2019; (b) PCT/International Patent Application No. PCT/CN2020/094333 filed Jun. 4, 2020.

The present application is related to the following patent applications: (a) Chinese Patent Application No. 201910496360.8 filed Jun. 10, 2019; (b) PCT/International Patent Application No. PCT/CN2020/095060 filed Jun. 9, 2020.

### FIELD

The present invention relates to an air vent system for a vehicle interior.

### BACKGROUND

It is known to provide an air vent system for a vehicle interior.

It would be advantageous to provide an improved air vent assembly/system with a set of airflow guides configured to be actuated/directed by operation of a drive mechanism with a single motor.

### SUMMARY

The present invention relates to an air vent assembly configured for a vehicle interior comprising an inner airflow guide, an outer airflow guide and a drive mechanism comprising an inner airflow mechanism configured to actuate the inner airflow guide and an outer airflow mechanism configured to actuate the outer airflow guide. The drive mechanism may be configured to be operated in a first direction and a second direction. The drive mechanism may be configured so that (1) when operated in the first direction the inner airflow mechanism is actuated and (2) when operated in the second direction the outer airflow mechanism is actuated. The drive mechanism may be configured so that when operated in the first direction only the inner airflow mechanism for the inner airflow guide is actuated. The drive mechanism may be configured so that when operated in the second direction only the outer airflow mechanism for the outer airflow guide is actuated. The drive mechanism may comprise a clutch mechanism configured (1) to engage the inner airflow mechanism when operated in the first direction and (2) to engage the outer airflow mechanism when operated in the second direction. The clutch mechanism may comprise a set of one-way bearings. The set of one-way bearings may comprise a one-way bearing for the inner airflow mechanism and a one-way bearing for the outer airflow mechanism. The assembly may comprise a motor configured to operate the drive mechanism; the motor may be configured to operate a shaft to operate the drive mechanism. Operation of the drive mechanism in the first direction may comprise rotation of the shaft in the first direction, and operation of the drive mechanism in the second direction may comprise rotation of the shaft in the second direction. The first direction may be opposite to the second direction. The inner airflow mechanism may comprise a gear and a connecting rod coupled to the inner airflow guide. The outer airflow mechanism may comprise a cam and a follower coupled to the outer airflow guide. The inner airflow guide may be configured to direct airflow in a first airflow direction, and the outer airflow guide may be configured to direct airflow in a second airflow direction. The inner airflow guide may comprise an inner blade set comprising a plurality of blades, and the outer airflow guide may comprise an outer blade set comprising a plurality of blades. The inner blade set may comprise a vertical blade set comprising a plurality of generally vertical blades, and the outer blade set may comprise a horizontal blade set comprising a plurality of generally horizontal blades.

The present invention relates to an air vent assembly configured for a vehicle interior comprising an inner blade set comprising a plurality of blades, an outer blade set comprising a plurality of blades and a drive mechanism configured to be operated in a first direction and a second direction. The drive mechanism may comprise an inner blade mechanism configured to actuate the inner blade set. The drive mechanism may comprise an outer blade mechanism configured to actuate the outer blade set. The drive mechanism may comprise a clutch assembly configured so that (1) when the drive mechanism is operated in the first direction the inner blade mechanism is actuated and (2) when the drive mechanism is operated in the second direction the outer blade mechanism is actuated. The clutch assembly may be configured so that (1) when the drive mechanism is operated in the first direction a clutch is engaged to actuate the inner blade mechanism and (2) when the drive mechanism is operated in the second direction a clutch is engaged to actuate the outer blade mechanism. The assembly may comprise a motor configured to operate the drive mechanism through a transmission in the first direction and in the second direction; the first direction may be opposite to the second direction.

The present invention relates to an air vent system configured for a vehicle interior comprising a vertical blade set comprising a plurality of generally vertical blades, a horizontal blade set comprising a plurality of generally horizontal blades, a drive mechanism configured to be operated in a first direction and a second direction and a motor configured to operate the drive mechanism through a transmission in the first direction and in the second direction. The drive mechanism may comprise a vertical blade mechanism configured to actuate the vertical blade set. The drive mechanism may comprise a horizontal blade mechanism configured to actuate the horizontal blade set. The drive mechanism may be configured so that (1) when operated in the first direction only the vertical blade mechanism is actuated and (2) when operated in the second direction only the horizontal blade mechanism is actuated. The drive mechanism may comprise a clutch assembly configured so that (1) when the drive mechanism is operated in the first direction the vertical blade mechanism is actuated through a clutch for the first direction and (2) when the drive mechanism is operated in the second direction the horizontal blade mechanism is actuated through a clutch for the second direction. The clutch assembly may be configured so that (1) when the drive mechanism is operated in the first direction the clutch for the first direction is engaged so that only the vertical blade mechanism is actuated to move the vertical blade set and the clutch for the second direction is disengaged and (2) when the drive mechanism is operated in the second direction the clutch for the second direction is engaged so that only the horizontal blade mechanism is actuated to move the horizontal blade set and the clutch for the first direction is disengaged.

The present invention relates to an air vent assembly configured for a vehicle interior comprising a vertical blade set comprising a plurality of generally vertical blades, a horizontal blade set comprising a plurality of generally horizontal blades and a drive mechanism configured to be operated in a first direction and a second direction. The drive mechanism may comprise a vertical blade mechanism configured to actuate the vertical blade set. The drive mechanism may comprise a horizontal blade mechanism configured to actuate the horizontal blade set. The drive mechanism may comprise a clutch assembly configured so that (1) when the drive mechanism is operated in the first direction the vertical blade mechanism is actuated and (2) when the drive mechanism is operated in the second direction the horizontal blade mechanism is actuated. The clutch assembly may be configured so that (1) when the drive mechanism is operated in the first direction a clutch is engaged to actuate the vertical blade mechanism and (2) when the drive mechanism is operated in the second direction a clutch is engaged to actuate the horizontal blade mechanism. The clutch assembly may comprise a stack of one-way bearings. The assembly may comprise a motor configured to operate the drive mechanism through a transmission in the first direction and in the second direction; the first direction may be opposite to the second direction.

The present invention relates to an air vent assembly configured for a vehicle interior comprising an inner blade set comprising a plurality of generally inner blades, an outer blade set comprising a plurality of generally outer blades and a drive mechanism comprising an inner blade mechanism configured to actuate the inner blade set and an outer blade mechanism configured to actuate the outer blade set. The drive mechanism may be configured to be operated in a first direction and a second direction. The drive mechanism may be configured so that (1) when operated in the first direction the inner blade mechanism is actuated and (2) when operated in the second direction the outer blade mechanism is actuated. The drive mechanism may be configured so that when operated in the first direction only the inner blade mechanism is actuated. The drive mechanism may be configured so that when operated in the second direction only the outer blade mechanism is actuated. The drive mechanism may comprise a clutch mechanism configured (1) to engage the inner blade mechanism when operated in the first direction and (2) to engage the outer blade mechanism when operated in the second direction. The clutch mechanism may comprise a one-way bearing. The first direction may be opposite to the second direction. The assembly may comprise a motor configured to operate the drive mechanism. The motor may be configured to operate a shaft to operate the drive mechanism. Operation of the drive mechanism in the first direction may comprise rotation of the shaft in the first direction and operation of the drive mechanism in the second direction may comprise rotation of the shaft in the second direction. The inner blade mechanism may comprise a gear and a connecting rod coupled to the inner blade set. The inner blade mechanism may comprise a rack and pinion. The outer blade mechanism may comprise a cam and a follower coupled to the outer blade set. The cam may comprise a spiral cam. The inner blade set may comprise a vertical blade set comprising a plurality of generally vertical blades, and the outer blade set may comprise a horizontal blade set comprising a plurality of generally horizontal blades. The inner airflow mechanism may comprise a gear and a connecting rod coupled to the inner airflow guide. The inner airflow mechanism may comprise a rack and pinion. The outer airflow mechanism may comprise a cam and a follower coupled to the outer airflow guide. The inner airflow guide may be configured to direct airflow in a first airflow direction and the outer airflow guide may be configured to direct airflow in a second airflow direction. The inner airflow guide may be configured to direct airflow in a generally horizontal direction and the outer airflow guide may be configured to direct airflow in a generally vertical direction. The inner airflow guide may comprise an inner blade set comprising a plurality of vanes, and the outer airflow guide may comprise an outer blade set comprising a plurality of vanes. The inner blade set may comprise a vertical blade set comprising a plurality of generally vertical vanes, and the outer vanes set may comprise a horizontal blade set comprising a plurality of generally horizontal vanes.

The present invention relates to an air vent assembly configured for a vehicle interior comprising a vertical blade set comprising a plurality of generally vertical blades, a horizontal blade set comprising a plurality of generally horizontal blades and a drive mechanism comprising a vertical blade mechanism configured to actuate the vertical blade set and a horizontal blade mechanism configured to actuate the horizontal blade set. The drive mechanism may be configured to be operated in a first direction and a second direction. The drive mechanism may be configured so that (1) when operated in the first direction the vertical blade mechanism is actuated and (2) when operated in the second direction the horizontal blade mechanism is actuated. The drive mechanism may be configured so that when operated in the first direction only the vertical blade mechanism is actuated. The drive mechanism may be configured so that when operated in the second direction only the horizontal blade mechanism is actuated. The drive mechanism may comprise a clutch mechanism configured (1) to engage the vertical blade mechanism when operated in the first direction and (2) to engage the horizontal blade mechanism when operated in the second direction. The clutch mechanism may comprise a one-way bearing. The first direction may be opposite to the second direction. The assembly may comprise a motor configured to operate the drive mechanism. The motor may be configured to operate a shaft to operate the drive mechanism. Operation of the drive mechanism in the first direction may comprise rotation of the shaft in the first direction and operation of the drive mechanism in the second direction may comprise rotation of the shaft in the second direction. The vertical blade mechanism may comprise a gear and a connecting rod coupled to the vertical blade set. The vertical blade mechanism may comprise a rack and pinion. The horizontal blade mechanism may comprise a cam and a follower coupled to the horizontal blade set. The cam may comprise a spiral cam.

The present invention relates to a vehicle interior component providing a passage for airflow and comprising a vertical guide configured to guide airflow, a horizontal guide configured to guide airflow, a motor configured to move the horizontal guide between a lower position and an upper position and to move the vertical guide between a left position and a right position, and a transmission mechanism coupled to the motor, the vertical guide and the horizontal guide. The transmission mechanism may comprise a clutch mechanism. The clutch mechanism may comprise a first clutch coupled to the vertical guide and a second clutch coupled to the horizontal guide. The motor may be configured to move the first clutch to move the vertical guide between the left position and the right position. The motor may be configured to move the second clutch to move the horizontal guide between the lower position and the upper position. The vertical guide may comprise a set of vanes; the horizontal guide may comprise a set of vanes.

The present invention relates to a vehicle interior component providing a passage for airflow and comprising a vertical guide configured to guide airflow, a horizontal guide configured to guide airflow, and a motor comprising a shaft and configured to move the vertical guide between a left position and a right position; and to move the horizontal guide between a lower position and an upper position. The motor may be configured to rotate the shaft in a first direction to move the vertical guide with the horizontal guide fixed to rotate the shaft in a section direction to move the horizontal guide with the vertical guide fixed.

The present invention relates to a vehicle interior component providing a passage for airflow and comprising a vertical guide configured to guide airflow, a horizontal guide configured to guide airflow, a motor configured to move the horizontal guide between a lower position and an upper position and to move the vertical guide between a left position and a right position, and a transmission mechanism coupled to the motor, the vertical guide and the horizontal guide. The transmission mechanism may comprise a gear configured to move a first arm to move the vertical guide between the left position and the right position; and a disk comprising a ramp configured to move a second arm to move the horizontal guide between the lower position and the upper position.

The present invention relates to an air outlet comprising a motor comprising an output shaft, a first one-way bearing and a second one-way bearing, both being coupled to the motor, an inner air guiding device coupled to the first one-way bearing and an outer air guiding device coupled to the second one-way bearing. By means of forward and reverse rotation of the output shaft, the motor is capable of 1) driving the inner air guiding device through the first one-way bearing, and 2) driving the outer air guiding device to switch between two states through the second one-way bearing. The first one-way bearing may comprise a first inner ring and a first outer ring, and the second one-way bearing may comprise a second inner ring and a second outer ring; the first outer ring and the second outer ring may have opposite directions of unidirectional rotation. The first one-way bearing and the second one-way bearing may be stacked on each other. The output shaft may be sleeved in the first inner ring and the second inner ring; the inner air guiding device may be coupled to the first outer ring, and the outer air guiding device may be coupled to the second outer ring. The output shaft may serve as the first inner ring and the second inner ring. The air outlet may comprise an inner air guiding device transmission mechanism and an outer air guiding device transmission mechanism, the inner air guiding device may be coupled to the first outer ring through the inner air guiding device transmission mechanism, and the outer air guiding device may be coupled to the second outer ring through the outer air guiding device transmission mechanism. The inner air guiding device transmission mechanism may comprise a connecting rod, one end of the connecting rod may be coupled to the inner air guiding device and the other end of the connecting rod may be coupled to the first outer ring. The inner air guiding device transmission mechanism may comprise a gear set, one gear of the gear set may be arranged outside the first outer ring, and the other end of the connecting rod may be eccentrically connected to the other gear of the gear set. The outer air guiding device transmission mechanism may comprise a transmission rod, one end of the transmission rod may be coupled to the outer air guiding device and the other end may be coupled to the second outer ring. The transmission rod may be provided with a track groove protrusion, and outside the second outer ring may be provided with a track groove, the track groove protrusion may be fit for moving in the track groove. The inner air guiding device may be a blade, a roller or a moving block, and the outer air guiding device may be a blade, a roller or a moving block. The outer air guiding device may be a set of outer blades comprising two outer blades arranged in parallel, and each of the outer blades may comprise two blades hinged to each other.

### FIGURES

FIGS. 1A and 1B are schematic perspective views of a vehicle providing an interior according to an exemplary embodiment.

FIG. 1C is a schematic perspective view of a vehicle interior according to an exemplary embodiment.

FIG. 2 is a schematic diagram of an air vent system for a vehicle interior according to an exemplary embodiment.

FIG. 3 is a schematic partial perspective view of an air vent system for a vehicle interior according to an exemplary embodiment.

FIGS. 4A to 4B are schematic partial perspective views of an air vent system for a vehicle interior according to an exemplary embodiment.

FIGS. 5A to 5B are schematic partial perspective views of an air vent system for a vehicle interior according to an exemplary embodiment.

FIG. 6 is a schematic exploded perspective view of an air vent system for a vehicle interior according to an exemplary embodiment.

FIG. 7 is a schematic perspective view of an air vent system for a vehicle interior according to an exemplary embodiment.

FIG. 8 is a schematic partial perspective view of an air vent system for a vehicle interior according to an exemplary embodiment.

FIG. 9 is schematic partial section view of an air vent system for a vehicle interior according to an exemplary embodiment.

FIGS. 10A to 10B are schematic partial perspective views of an air vent system for a vehicle interior according to an exemplary embodiment.

FIGS. 11A to 11B are schematic partial perspective views of an air vent system for a vehicle interior according to an exemplary embodiment.

FIGS. 12A to 12B are schematic partial perspective views of an air vent system for a vehicle interior according to an exemplary embodiment.

FIGS. 13A to 13B are schematic partial perspective views of an air vent system for a vehicle interior according to an exemplary embodiment.

FIGS. 14A to 14B are schematic partial section views of an air vent system for a vehicle interior according to an exemplary embodiment.

FIG. 15 is a schematic partial perspective view of an air vent system for a vehicle interior according to an exemplary embodiment.

FIG. 16 is a schematic partial perspective view of an air vent system for a vehicle interior according to an exemplary embodiment.

FIG. 17 is a schematic partial perspective view of an air vent system for a vehicle interior according to an exemplary embodiment.

FIG. 18 is a schematic partial perspective view of an air vent system for a vehicle interior according to an exemplary embodiment.

FIG. 19 is a schematic partial perspective view of an air vent system for a vehicle interior according to an exemplary embodiment.

FIG. 20 is a schematic partial section view of an air vent system for a vehicle interior according to an exemplary embodiment.

FIG. 21 is a schematic diagram of an air vent system for a vehicle interior according to an exemplary embodiment.

FIGS. 22A to 22B are schematic cutaway section views of an air vent system for a vehicle interior according to an exemplary embodiment.

FIG. 23 is a schematic partial perspective view of an air vent system for a vehicle interior according to an exemplary embodiment.

FIGS. 24A to 24C are schematic partial perspective views of an air vent system for a vehicle interior according to an exemplary embodiment.

FIG. 25A is a schematic diagram of a cam surface/groove on a shaft for a drive mechanism for an air vent system for a vehicle interior according to an exemplary embodiment.

FIG. 25B is a schematic diagram of a shaft with a cam surface/groove for a drive mechanism for an air vent system for a vehicle interior according to an exemplary embodiment.

FIG. 26 is a schematic partial perspective view of an air vent system for a vehicle interior according to an exemplary embodiment.

FIG. 27 is a schematic partial perspective view of an air vent system for a vehicle interior according to an exemplary embodiment.

FIGS. 28A to 28B are schematic partial perspective views of an air vent system for a vehicle interior according to an exemplary embodiment.

FIGS. 29A to 29B are schematic partial perspective views of an air vent system for a vehicle interior according to an exemplary embodiment.

FIGS. 30A to 30B are schematic partial perspective views of an air vent system for a vehicle interior according to an exemplary embodiment.

FIGS. 31A to 31B are schematic partial perspective views of an air vent system for a vehicle interior according to an exemplary embodiment.

FIG. 32 is a schematic diagram of an air vent system for a vehicle interior according to an exemplary embodiment.

FIGS. 33A to 33B are schematic cutaway section views of an air vent system for a vehicle interior according to an exemplary embodiment.

FIGS. 34A to 34C are schematic partial perspective views of an air vent system for a vehicle interior according to an exemplary embodiment.

FIGS. 35A and 35B are tables indicating operation of the drive mechanism of the air vent system for a vehicle interior according to an exemplary embodiment.

### DESCRIPTION

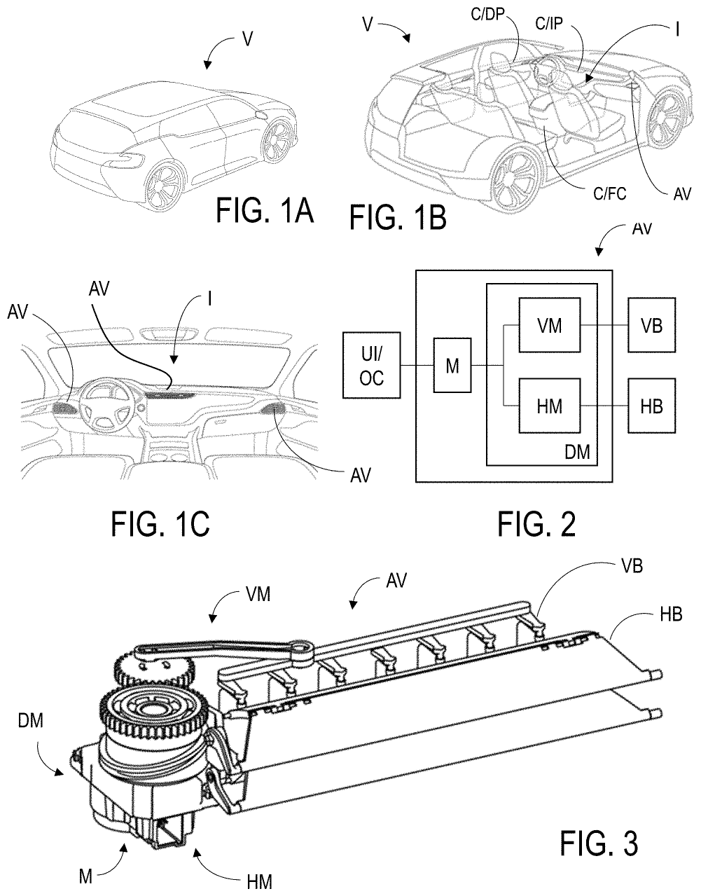

Referring to FIGS. 1A-1C, a vehicle V is shown according to an exemplary embodiment comprising an interior I providing components C such as an instrument panel IP, door panel DP, floor console FC, etc. As indicated in FIGS. 1B and 1C, one or more component of the vehicle interior may comprise an air vent assembly/system AV with an inlet/connection to airflow from the heating/cooling/ventilation system of the vehicle and providing an outlet for airflow into the vehicle interior.

As shown schematically in FIGS. 2 and 3, the air vent assembly/system provided for a vehicle interior (e.g. providing an outlet into the vehicle interior from an inlet from the vehicle heating/cooling/ventilation system) may comprise a user interface/operator control UI/OC and a drive mechanism DM operated by a motor M; the air vent system/assembly may comprise an inner airflow guide mechanism VM for an inner airflow guide shown as comprising inner/vertical blade set VB and an outer airflow guide mechanism HM for an outer airflow guide shown as comprising outer/horizontal blade set HB. As indicated schematically in FIGS. 2, 3, 4A-4B and 5A-5B, drive mechanism DM may comprise inner airflow mechanism VM configured to actuate inner airflow guide VB and outer airflow mechanism HB configured to actuate outer airflow guide HB. As indicated schematically in FIGS. 2, 3, 4A-4B, 5A-5B, 21, 24A-24C, 32, 34A-34C and 35A-35B, the drive mechanism may be configured to be operated in a first direction and a second direction; the drive mechanism may be configured so that (1) when operated in the first direction the inner airflow mechanism is actuated (e.g. directed/moved to guide airflow to an outlet) and (2) when operated in the second direction the outer airflow mechanism is actuated (e.g. directed/moved to guide airflow to an outlet).

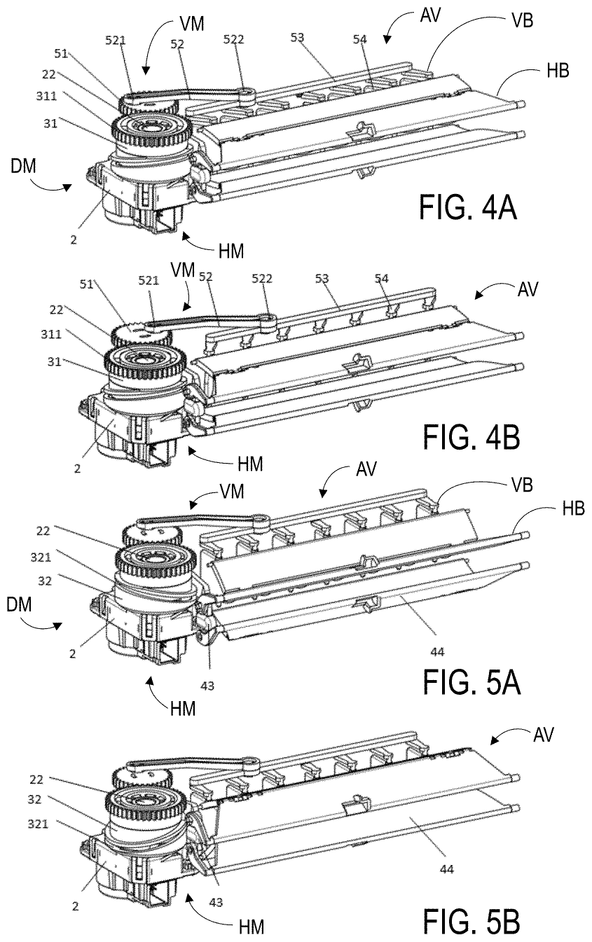

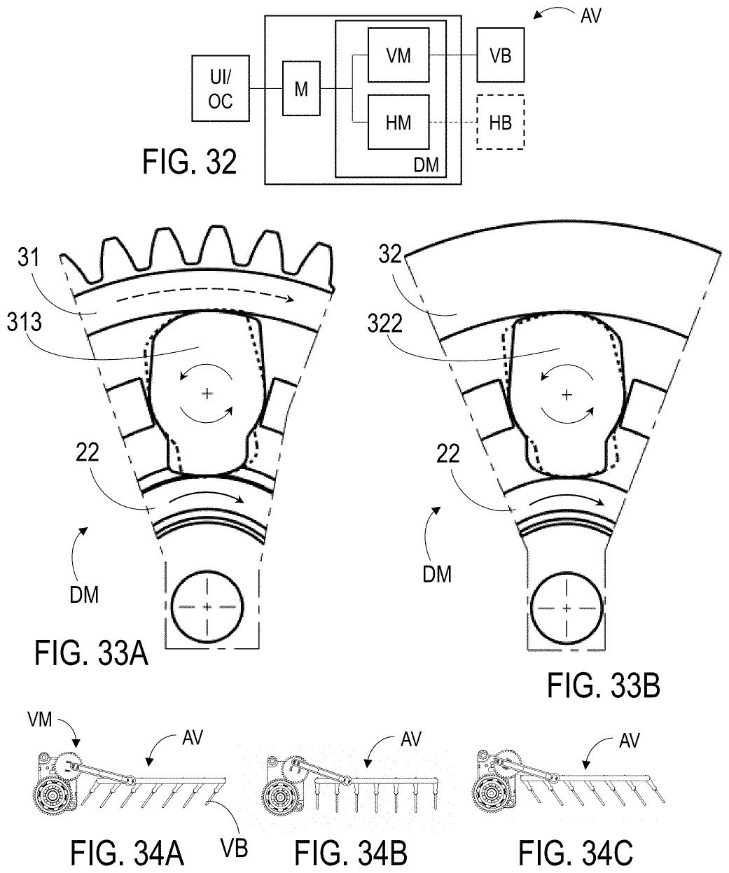

As indicated schematically in FIGS. 32, 33A-33B, 34A-34C and 35A, drive mechanism DM may be configured so that when operated in the first direction only inner airflow mechanism VM for inner airflow guide VB is actuated (e.g. lateral/horizontal movement between left/center/right positions). See also FIGS. 4A-4B, 26, 27, 28A-28B, 29A-29B, 30A-30B and 31A-31B.

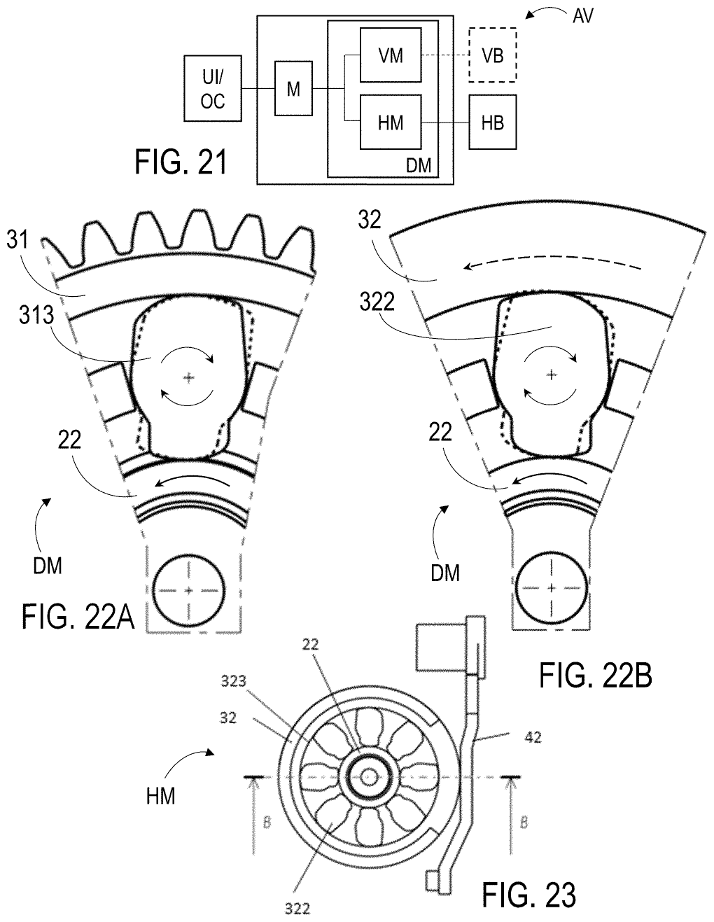

As indicated schematically in FIGS. 21, 22A-22B, 24A-24C and 35B, drive mechanism DM may be configured so that when operated in the second direction only outer airflow mechanism HM for outer airflow guide HB is actuated (e.g. vertical movement between up/center/down positions). See also FIGS. 5A-5B, 10A-10B, 11A-11B, 12A-12B, 23 and 25A-25B.

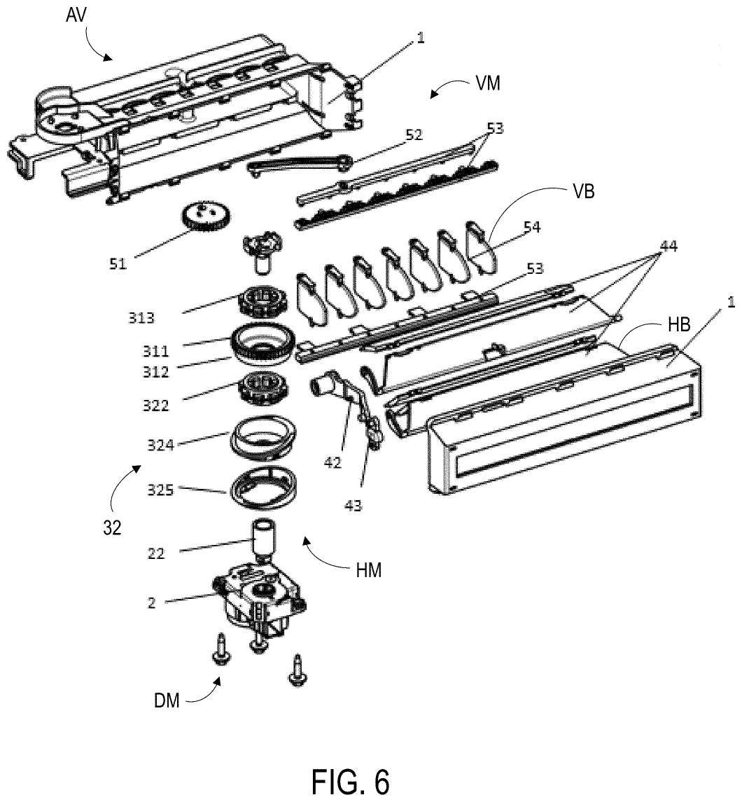

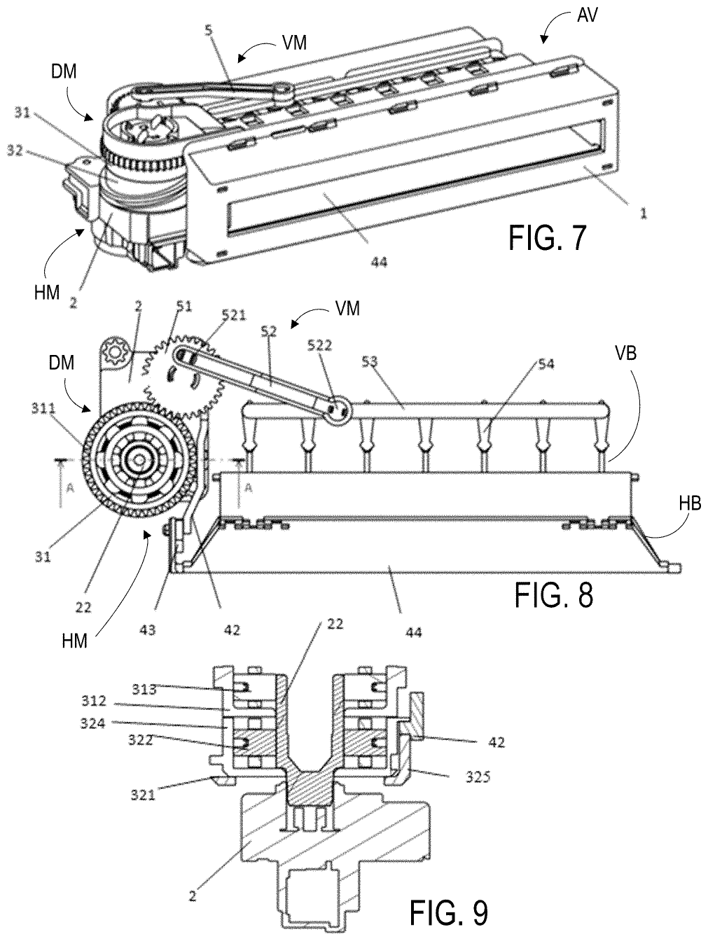

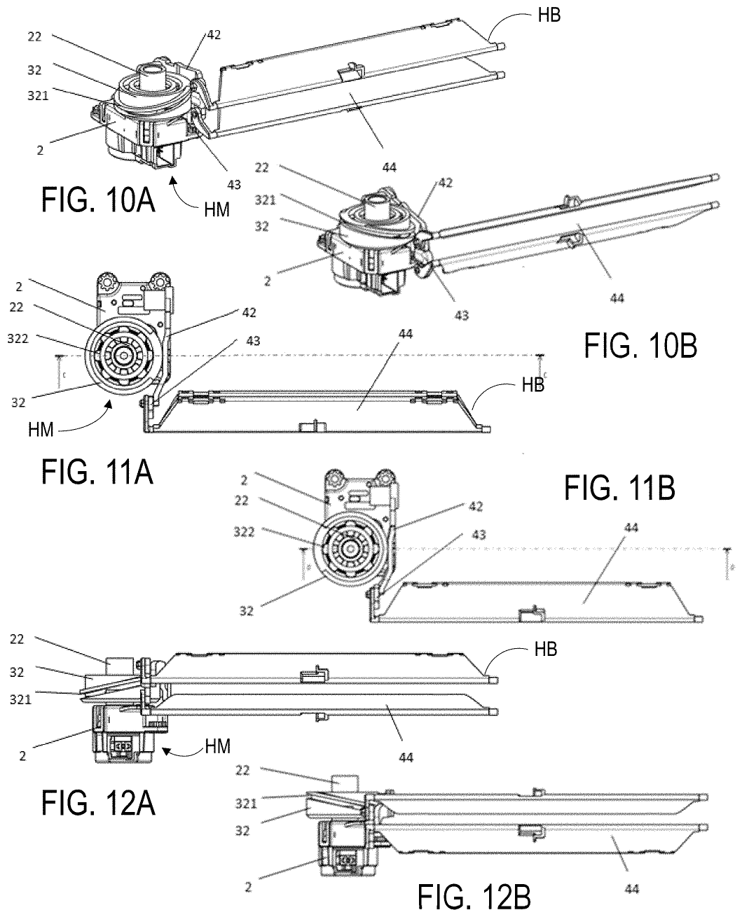

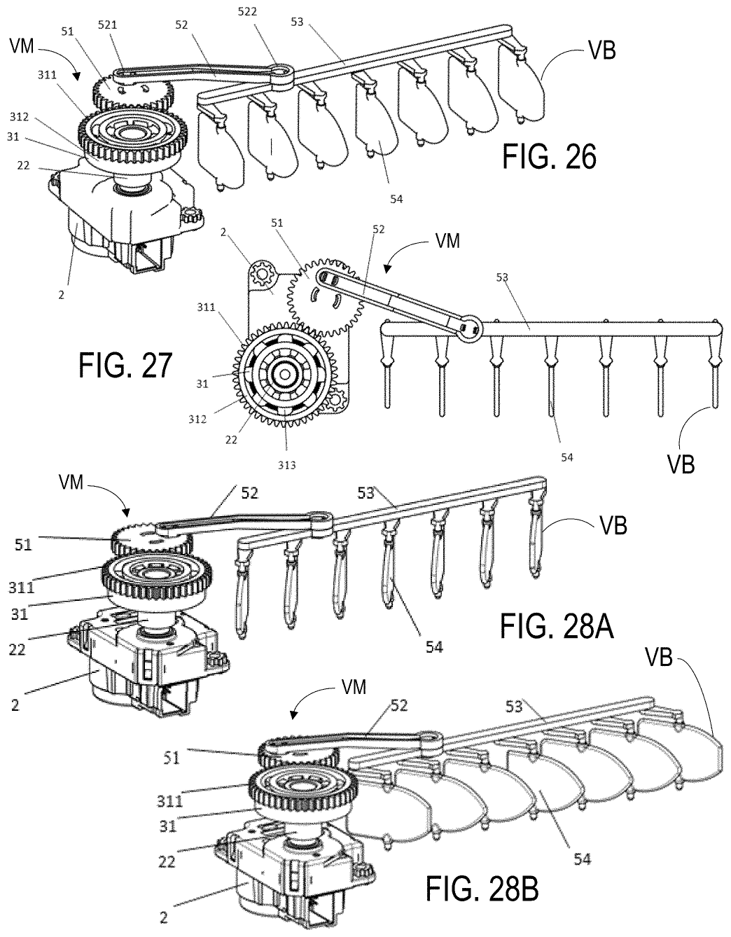

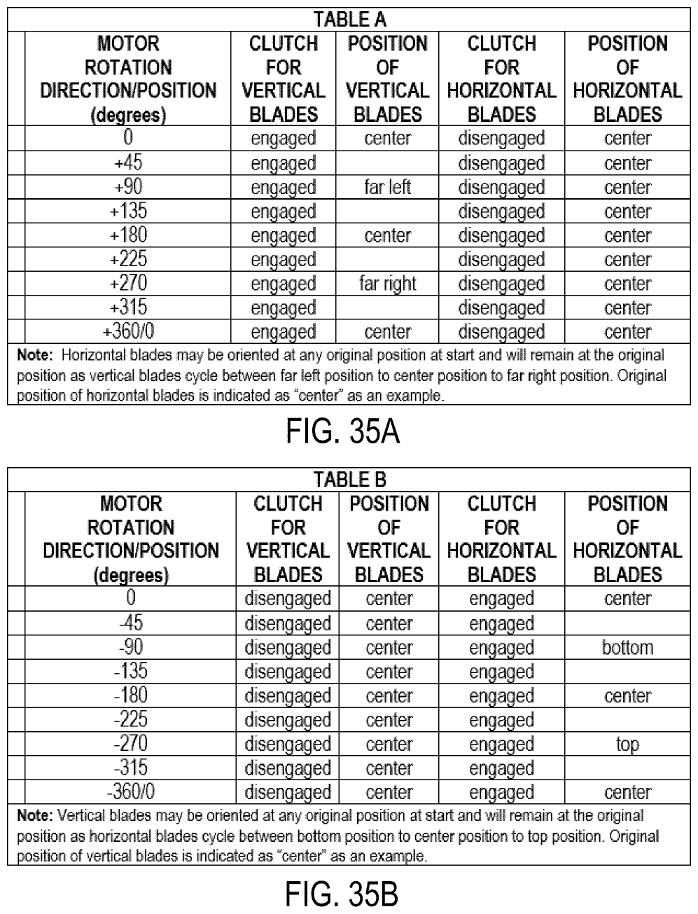

As indicated schematically according to an exemplary embodiment in FIGS. 4A-4B, 5A-5B, 6, 21, 22A-22B, 24A-24C, 32, 33A-33B, 34A-34C and 35A-35B, drive mechanism DM may comprise a clutch mechanism CM configured (1) to engage inner airflow mechanism VM when operated in the first direction and (2) to engage outer airflow mechanism HM when operated in the second direction. As indicated schematically in FIGS. 6, 22A-22B and 33A-33B, clutch mechanism CM may comprise a set of one-way bearings; the set of one-way bearings may comprise a one-way bearing for inner airflow mechanism VM and a one-way bearing for outer airflow mechanism HM. As indicated schematically in FIGS. 2, 3, 4A-4B, 5A-5B, 6, 21, 22A-22B, 23, 24A-24B, 32, 33A-33B, the air vent assembly may comprise a motor M configured to operate drive mechanism DM; motor M may be configured to operate a shaft to operate drive mechanism DM; operation of drive mechanism DM in the first direction may comprise rotation of the shaft in the first direction to actuate inner airflow guide mechanism VM/VB, and operation of drive mechanism DM in the second direction may comprise rotation of the shaft in the second direction to actuate outer airflow guide mechanism HM/HB; the first direction may be opposite to the second direction. See also FIGS. 35A and 35B (e.g. forward and/or reverse). As indicated schematically in FIGS. 3, 4A-4B, 6 and 34A-34C, inner airflow mechanism VM may comprise a gear and a connecting rod coupled to inner airflow guide VB. See also FIGS. 26, 27, 28A-28B, 29A-29B, 30A-30B, 31A-31B and 32. As indicated schematically in FIGS. 3, 5A-5B, 6 and 24A-24C, outer airflow mechanism HM may comprise a cam and a follower coupled to outer airflow guide HB. See also FIGS. 10A-10B, 11A-11B, 12A-12B, 21, 23 and 25A-25B.

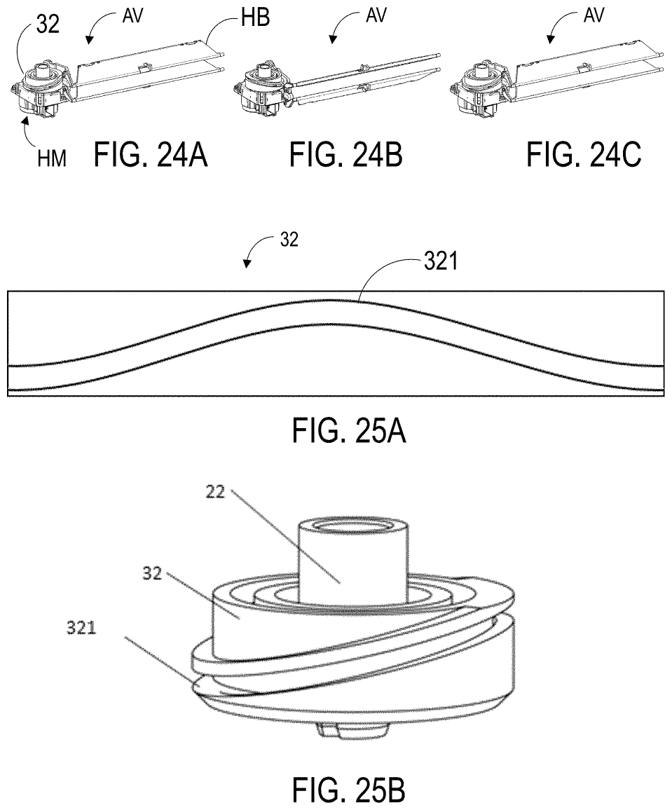

According to an exemplary embodiment as indicated schematically in the FIGURES, the inner airflow guide may be configured to direct airflow in a first airflow direction; the outer airflow guide may be configured to direct airflow in a second airflow direction. See FIGS. 3, 4A-4B, 5A-5B, 24A-24C and 34A-34C. According to an exemplary embodiment as shown schematically in FIGS. 3, 4A-4B, 5A-5B and 6, the inner airflow guide may comprise an inner blade set comprising a plurality of blades and the outer airflow guide may comprise an outer blade set comprising a plurality of blades; the inner blade set may comprise a vertical blade set comprising a plurality of generally vertical blades, and the outer blade set may comprise a horizontal blade set comprising a plurality of generally horizontal blades. See also FIGS. 24A-24C and 34A-34C.

As indicated schematically in FIGS. 2, 3, 35A and 35B, operation of the air vent system to direct airflow with the drive mechanism with clutch arrangement by an operator control at a user interface UI in a first direction will actuate inner/vertical blade set mechanism VM/VB and in a second direction will actuate outer/horizontal blade set mechanism HM/HB. See also FIGS. 21, 24A-24C, 32 and 34A-34C.

### Exemplary Embodiments—A

According to an exemplary embodiment as shown schematically in FIGS. 1A-1C and 2, a vehicle V may comprise an interior having a dashboard with an air vent system AV shown as an air vent outlet comprising air outlets; as indicated schematically, system AV may be arranged in the center of and on both sides of the dashboard, or arranged only in the center of the dashboard, or arranged in any other position as needed. See FIGS. 1B and 1C.

According to an exemplary embodiment as shown schematically in FIGS. 2, 3 and 6, air vent system/outlet AV may comprise a motor 2, an output shaft 22, a first one-way bearing 31, a second one-way bearing 32, outer blades 44, inner blades 54, and a housing 1. Inner blades 54 and outer blades 44 may be arranged within housing 1. Output shaft 22 may be arranged on motor 2 and may be configured to pass through first one-way bearing 31 and second one-way bearing 32; a track groove 321 may be provided along the circumference of second one-way bearing 32, and a gear 311 may be provided along the circumference of first one-way bearing 31. The air outlet may comprise a transmission gear 51, a connecting rod 52, an inner blade connecting rod 53 and an outer blade connecting rod 43. Both first one-way bearing 31 and second one-way bearing 32 may be coupled to motor 2. Inner blades 54 may be coupled to first one-way bearing 31 and outer blades 44 may be coupled to second one-way bearing 32. By forward and reverse rotation of output shaft 22, motor 2 may drive inner blades 54 and outer blades 44 through first one-way bearing 31 and second one-way bearing 32, respectively. According to an exemplary embodiment as shown schematically in FIG. 6, first one-way bearing 31 and second one-way bearing 32 may be stacked on each other with first one-way bearing 31 located above second one-way bearing 32.

According to an exemplary embodiment as shown schematically in FIGS. 8 and 9, first one-way bearing 31 may comprise a first inner ring and a first outer ring 312, and second one-way bearing 32 may comprise a second inner ring and a second outer ring. The second outer ring may be assembled from an upper ring component 324 and a lower ring component 325 to form track groove 321 between upper ring component 324 and lower ring component 325; in the second outer ring, upper ring component 324 may provide an upper inner surface of track groove 321, and lower ring component 325 may provide a lower inner surface of track groove 321. Such configuration may facilitate demolding in the manufacture of the second outer ring. First outer ring 312 and the second outer ring may have opposite directions of unidirectional rotation; output shaft 22 may be mounted on motor 2, and may be configured to pass through first one-way bearing 31 and second one-way bearing 32 and then sleeved in the first inner ring and the second inner ring (in the illustrated embodiment, output shaft 22 may serve as the first inner ring and the second inner ring, so the additional first inner ring and the second inner ring may be omitted); transmission rod 42 may be engaged with second one-way bearing 32 in the Z-direction through track groove 321; when the second outer ring of second one-way bearing 32 rotates, a driving rod 42 may change the height in the Z-direction according to the position of track groove 321.

According to an exemplary embodiment as shown schematically in FIGS. 3, 4A-4B, 26 and 27, an inner blade transmission mechanism of the air outlet in may be configured for blowing rightward (FIG. 4A) or for blowing leftward (FIG. 4B). Inner blades 54 may be coupled to first outer ring 312 through an inner blade transmission mechanism. The inner blade transmission mechanism may comprise an inner blade connecting rod 53 coupled to pivot shafts of inner blades 54. The inner blade transmission mechanism may comprise a connecting rod 52; one end of connecting rod 52 may be provided with a first connecting rod rotating shaft 522 and the other end of connecting rod 52 may be provided with a second connecting rod rotating shaft 521, and connecting rod 52 may be connected to inner blade connecting rod 53 through first connecting rod rotating shaft 522 and may be coupled to first outer ring 312 through second connecting rod rotating shaft 521. The inner blade transmission mechanism may comprise a gear set; one gear 311 of the gear set may be arranged outside first outer ring 312, and connecting rod 52 may be eccentrically connected to the other gear of the gear set, i.e., transmission gear 51, through second connecting rod rotating shaft 521.

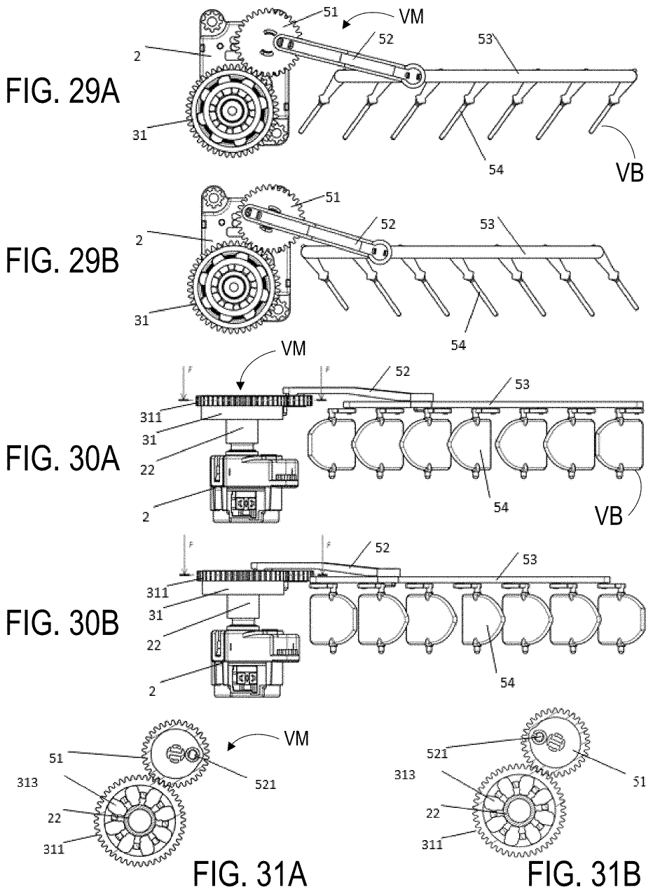

According to an exemplary embodiment as shown schematically in the FIGURES, when motor 2 rotates clockwise, output shaft 22 rotates clockwise, second one-way bearing 32 slips and does not rotate, first one-way bearing 31 is engaged to transmit the rotation of output shaft 22 to gear 311 of first outer ring 312, and gear 311 is engaged with transmission gear 51 to drive the transmission gear to rotate; second connecting rod rotating shaft 521 at one end of connecting rod 52 is eccentrically arranged on transmission gear 51, so that the rotation is converted into the reciprocation of first connecting rod rotating shaft 522 at the other end along the Y-direction so as to drive inner blade connecting rod 53 to reciprocate and inner blades 54 to swing from side to side. First wedges 313 are circumferentially arranged between output shaft 22 and an inner wall of first outer ring 312 of first one-way bearing 31; when output shaft 22 rotates counterclockwise, first wedges 313 slip and do not rotate; when output shaft 22 rotates clockwise, first wedges 313 are each engaged to lock the relative movement of output shaft 22 to the inner wall of first outer ring 312, causing first one-way bearing 32 to rotate clockwise. See also FIGS. 32, 33A-33B, 34A-34C and 35A (e.g. operation of clutch mechanism/one-way bearing with motor shaft rotation in first direction to actuate inner airflow mechanism/guide). As indicated schematically in FIGS. 4A-4B, 28A and 29A, transmission gear 51 may drive connecting rod 52 to push inner blade connecting rod 53 to the right, which drives inner blades 54 to deflect to the left; as indicated schematically in FIGS. 29A, 30A and 31A, gear 311 of first one-way bearing 31 drives transmission gear 51 to rotate, causing second connecting rod rotating shaft 521 to rotate to the right.

As indicated schematically in FIGS. 4A-4B, 28B and 29B, transmission gear 51 drives connecting rod 52 to pull inner blade connecting rod 53 to the left, which drives inner blades 54 to deflect to the right; as indicated schematically in FIGS. 29B, 30B and 31B, gear 311 of first one-way bearing 31 drives transmission gear 51 to rotate, causing second connecting rod rotating shaft 521 to rotate to the left.

As indicated schematically in FIGS. 3, 15, 5A-5B, 15 and 17, the outer blade transmission mechanism of the air outlet may be positioned for blowing upward (FIG. 5A) or blowing downward (FIG. 5B). Outer blades 44 may be coupled to the second outer ring through an outer blade transmission mechanism. The outer blade transmission mechanism may comprise an outer blade connecting rod 43 coupled to pivot shafts of outer blades 44. When motor 2 rotates counterclockwise, output shaft 22 rotates counterclockwise, first one-way bearing 31 slips and does not rotate, second one-way bearing 32 is engaged to transmit the rotation of output shaft 22 to track groove 321 of the second outer ring, and the different heights of track groove 321 in the Z-direction control the angle of swing of transmission rod 42 to further control the position of outer blade connecting rod 43 in the Z-direction, thus driving outer blades 44 to swing. See also FIGS. 21, 22A-22B, 23, 24A-24C, 25A-25B and 35B (e.g. operation of clutch mechanism/one-way bearing with motor shaft rotation in second direction to actuate outer airflow mechanism/guide).

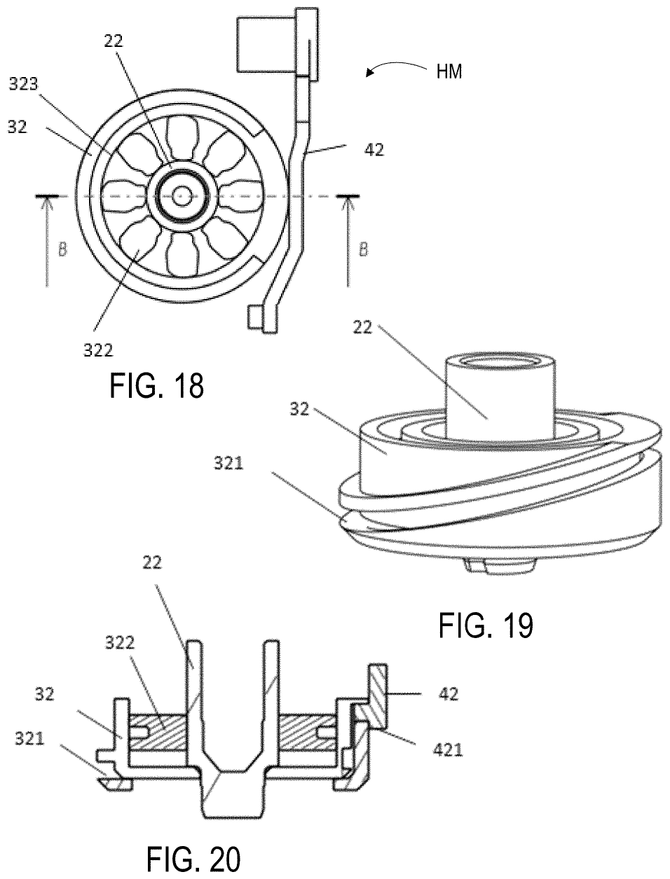

As indicated schematically in FIGS. 17 and 18, transmission rod 42 may be arranged tangential to the outside of second one-way bearing 32; second wedges 322 may be circumferentially arranged between output shaft 22 and an inner wall 323 of the second outer ring of second one-way bearing 32; when output shaft 22 rotates clockwise, second wedges 322 slip and do not rotate; when output shaft 22 rotates counterclockwise, second wedges 322 are engaged to lock the relative movement of output shaft 22 to inner wall 323, causing second one-way bearing 32 to rotate counterclockwise. As indicated schematically in FIGS. 18 and 27, second wedges 322 (FIG. 18) and first wedges 313 (FIG. 27) may be the same in configuration but arranged in opposite directions relative to the axial direction of output shaft 22, which enables first one-way bearing 31 and second one-way bearing 32 to be engaged in turn at the time of clockwise and counterclockwise rotation of output shaft 22, respectively, thus outputting the rotation in the two directions to the inner blades and outer blades.

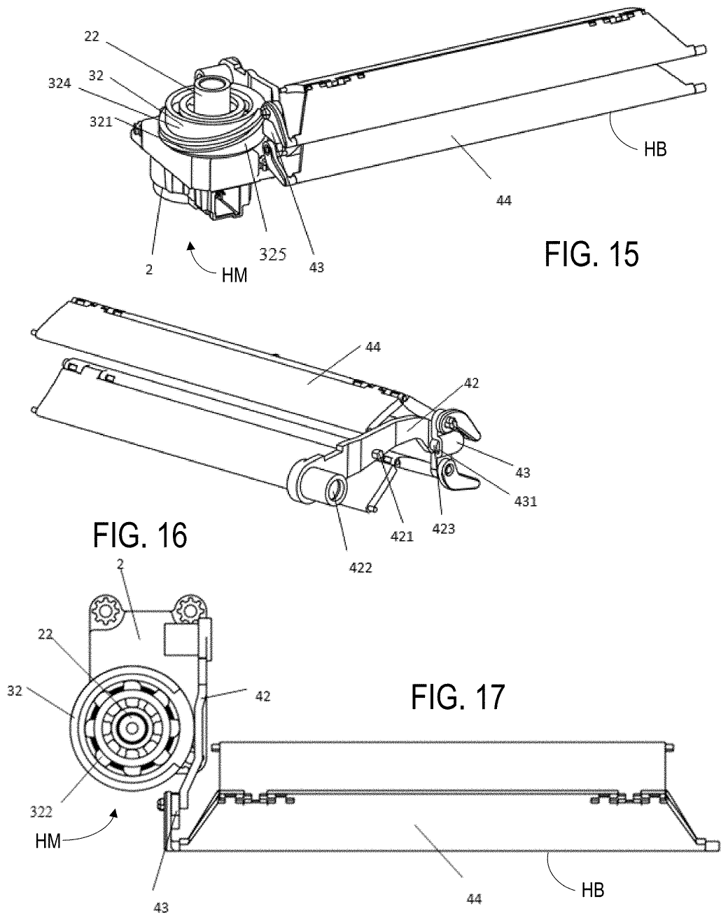

As indicated schematically in FIGS. 18 and 20, transmission rod 42 may comprise a track groove protrusion 421 embedded in track groove 321 of the second outer ring of second one-way bearing 32; when second one-way bearing 32 rotates, the position of track groove protrusion 421 moves up and down along the Z-direction under constraint of track groove 321. See also FIGS. 21, 22A-22B, 23, 24A-24C, 25A-25B and 35B (e.g. operation of clutch mechanism/one-way bearing with motor shaft rotation in second direction to actuate outer airflow mechanism/guide). As shown schematically in FIGS. 15, 19 and 25A-25B, track groove 321 may have an elliptical shape.

As shown schematically in FIGS. 15 and 16, transmission rod 42 may be provided with a transmission rod rotating shaft 422 that can be rotatably arranged on the housing of the air outlet; transmission rod 42 may be provided with a track groove protrusion 421 and a connecting rod protrusion 423; outer blade connecting rod 43 may be provided with a sliding groove 431; connecting rod protrusion 423 may be slidably constrained by sliding groove 431 along the X-direction, and when track groove protrusion 421 is driven to move up and down along the Z-direction, connecting rod protrusion 423 may drive outer blade connecting rod 43 to move along the Z-direction, thus driving outer blade 44 to swing up and down. See also FIGS. 21, 22A-22B, 23, 24A-24C, 25A-25B and 35B (e.g. operation of clutch mechanism/one-way bearing with motor shaft rotation in second direction to actuate outer airflow mechanism/guide).

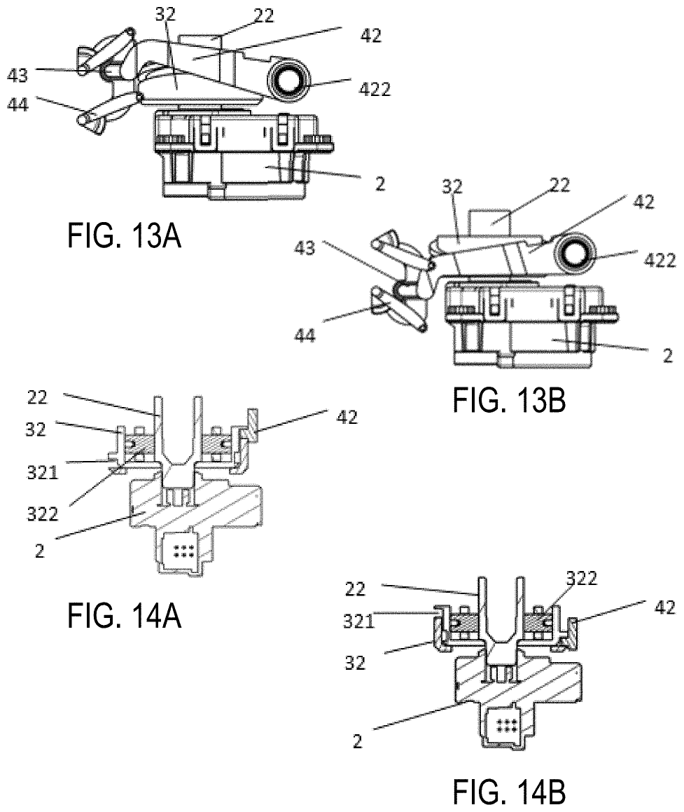

As shown schematically in FIGS. 5A, 10A, 11A and 14A, for the outer blade driving component of the air outlet blowing downward, the left side of track groove 321 of second one-way bearing 32 rotates to the lowest point and the right side rotates to the highest point to drive transmission rod 42 to swing upward to the highest point; as shown schematically in FIGS. 10A, 12A and 13A transmission rod 42 drives outer blade connecting rod 43 to move to the highest point, so that outer blades 44 are turned downward to the lower extreme position.

As shown schematically in FIGS. 5B, 10B, 11B and 14B, for the outer blade driving component of the air outlet blowing upward, the left side of track groove 321 of second one-way bearing 32 rotates to the highest point and the right side rotates to the lowest point to drive transmission rod 42 to swing downward to the lowest point; as shown schematically in FIGS. 10B, 12B and 13B, transmission rod 42 drives outer blade connecting rod 43 to move to the lowest point, so that outer blades 44 are turned upward to the upper extreme position.

According to an exemplary embodiment as shown schematically in FIGS. 3, 5A-5B and 6, two outer blades 44 are present and arranged in parallel, and each outer blade may comprise two blades hinged to each other; by rotating one of the blades, flow channels with different orientations can be formed, so that airflows in different directions are obtained; the outer blades may have the structure of a blade set, i.e., a structure similar to that of the inner blades. See FIGS. 4A-4B.

According to an exemplary embodiment, the inner air guiding device and the outer air guiding device may be in the form of a moving block or a roller (or combination); the inner and outer air guiding devices may be a combination of blades, a combination of a blade and a roller, or a combination of a moving block and a blade.

### Exemplary Embodiments—B

According to an exemplary embodiment as shown schematically in FIGS. 1B-1C, 2, 3, 4A-4B, 5A-5B, 6, 21, 22A-22B, 23, 24A-24C, 25A-25B, 32, 33A-33B, 34A-34C and 35A-35B, an air vent assembly/system is provided for a vehicle interior (e.g. providing an outlet into the vehicle interior from an inlet from the vehicle heating/cooling/ventilation system); the air vent system may comprise an inner airflow guide, an outer airflow guide and a drive mechanism comprising an inner airflow mechanism configured to actuate the inner airflow guide and an outer airflow mechanism configured to actuate the outer airflow guide; the drive mechanism may be configured to be operated in a first direction and a second direction; the drive mechanism may be configured so that (1) when operated in the first direction the inner airflow mechanism is actuated (e.g. directed/moved to guide airflow to an outlet) and (2) when operated in the second direction the outer airflow mechanism is actuated (e.g. directed/moved to guide airflow to an outlet); the drive mechanism may be configured so that when operated in the first direction only the inner airflow mechanism for the inner airflow guide is actuated; the drive mechanism may be configured so that when operated in the second direction only the outer airflow mechanism for the outer airflow guide is actuated; the drive mechanism may comprise a clutch mechanism configured (1) to engage the inner airflow mechanism when operated in the first direction and (2) to engage the outer airflow mechanism when operated in the second direction; the clutch mechanism may comprise a set of one-way bearings; the set of one-way bearings may comprise a one-way bearing for the inner airflow mechanism and a one-way bearing for the outer airflow mechanism; the assembly may comprise a motor configured to operate the drive mechanism; the motor may be configured to operate a shaft to operate the drive mechanism. As indicated schematically, operation of the drive mechanism in the first direction may comprise rotation of the shaft in the first direction, and operation of the drive mechanism in the second direction may comprise rotation of the shaft in the second direction; the first direction may be opposite to the second direction. See FIGS. 2, 3, 4A-4B, 5A-5B, 6, 21, 22A-22B, 23, 24A-24C, 25A-25B, 32, 33A-33B, 34A-34C and 35A-35B. As indicated schematically, the inner airflow mechanism may comprise a gear and a connecting rod coupled to the inner airflow guide; the outer airflow mechanism may comprise a cam and a follower coupled to the outer airflow guide; the inner airflow guide may be configured to direct airflow in a first airflow direction, and the outer airflow guide may be configured to direct airflow in a second airflow direction. See also FIGS. 35A-35B. As indicated schematically in FIGS. 3, 4A-4B, 5A-5B and 6, the inner airflow guide may comprise an inner blade set comprising a plurality of blades, and the outer airflow guide may comprise an outer blade set comprising a plurality of blades; the inner blade set may comprise a vertical blade set comprising a plurality of generally vertical blades, and the outer blade set may comprise a horizontal blade set comprising a plurality of generally horizontal blades.

According to an exemplary embodiment as shown schematically in FIGS. 1B-1C, 2, 3, 4A-4B, 5A-5B, 6, 21, 22A-22B, 23, 24A-24C, 25A-25B, 32, 33A-33B, 34A-34C and 35A-35B, an air vent assembly/system is provided for a vehicle interior; the air vent system may comprise an inner blade set comprising a plurality of blades, an outer blade set comprising a plurality of blades and a drive mechanism configured to be operated in a first direction and a second direction. The drive mechanism may comprise an inner blade mechanism configured to actuate the inner blade set. The drive mechanism may comprise an outer blade mechanism configured to actuate the outer blade set. The drive mechanism may comprise a clutch assembly configured so that (1) when the drive mechanism is operated in the first direction the inner blade mechanism is actuated and (2) when the drive mechanism is operated in the second direction the outer blade mechanism is actuated. The clutch assembly may be configured so that (1) when the drive mechanism is operated in the first direction a clutch is engaged to actuate the inner blade mechanism and (2) when the drive mechanism is operated in the second direction a clutch is engaged to actuate the outer blade mechanism. The assembly may comprise a motor configured to operate the drive mechanism through a transmission in the first direction and in the second direction; the first direction may be opposite to the second direction.

According to an exemplary embodiment as shown schematically in FIGS. 1B-1C, 2, 3, 4A-4B, 5A-5B, 6, 21, 22A-22B, 23, 24A-24C, 25A-25B, 32, 33A-33B, 34A-34C and 35A-35B, an air vent assembly/system is provided for a vehicle interior; the air vent system may comprise a vertical blade set comprising a plurality of generally vertical blades, a horizontal blade set comprising a plurality of generally horizontal blades, a drive mechanism configured to be operated in a first direction and a second direction and a motor configured to operate the drive mechanism through a transmission in the first direction and in the second direction. The drive mechanism may comprise a vertical blade mechanism configured to actuate the vertical blade set. The drive mechanism may comprise a horizontal blade mechanism configured to actuate the horizontal blade set. The drive mechanism may be configured so that (1) when operated in the first direction only the vertical blade mechanism is actuated and (2) when operated in the second direction only the horizontal blade mechanism is actuated. The drive mechanism may comprise a clutch assembly configured so that (1) when the drive mechanism is operated in the first direction the vertical blade mechanism is actuated through a clutch for the first direction and (2) when the drive mechanism is operated in the second direction the horizontal blade mechanism is actuated through a clutch for the second direction. As indicated schematically in FIGS. 21, 24A-24C, 32, 34A-34C and 35A-35B, the clutch assembly may be configured so that (1) when the drive mechanism is operated in the first direction the clutch for the first direction is engaged so that only the vertical blade mechanism is actuated to move the vertical blade set and the clutch for the second direction is disengaged and (2) when the drive mechanism is operated in the second direction the clutch for the second direction is engaged so that only the horizontal blade mechanism is actuated to move the horizontal blade set and the clutch for the first direction is disengaged. See also FIGS. 22A-22B and 33A-33B.

According to an exemplary embodiment as shown schematically in FIGS. 1B-1C, 2, 3, 4A-4B, 5A-5B, 6, 21, 22A-22B, 23, 24A-24C, 25A-25B, 32, 33A-33B, 34A-34C and 35A-35B, an air vent assembly/system is provided for a vehicle interior; the air vent system may comprise a vertical blade set comprising a plurality of generally vertical blades, a horizontal blade set comprising a plurality of generally horizontal blades and a drive mechanism configured to be operated in a first direction and a second direction. The drive mechanism may comprise a vertical blade mechanism configured to actuate the vertical blade set. The drive mechanism may comprise a horizontal blade mechanism configured to actuate the horizontal blade set. The drive mechanism may comprise a clutch assembly configured so that (1) when the drive mechanism is operated in the first direction the vertical blade mechanism is actuated and (2) when the drive mechanism is operated in the second direction the horizontal blade mechanism is actuated. The clutch assembly may be configured so that (1) when the drive mechanism is operated in the first direction a clutch is engaged to actuate the vertical blade mechanism and (2) when the drive mechanism is operated in the second direction a clutch is engaged to actuate the horizontal blade mechanism. The clutch assembly may comprise a stack of one-way bearings. The assembly may comprise a motor configured to operate the drive mechanism through a transmission in the first direction and in the second direction; the first direction may be opposite to the second direction.

According to an exemplary embodiment as shown schematically in FIGS. 1B-1C, 2, 3, 4A-4B, 5A-5B, 6, 21, 22A-22B, 23, 24A-24C, 25A-25B, 32, 33A-33B, 34A-34C and 35A-35B, an air vent assembly/system is provided for a vehicle interior; the air vent system may comprise an inner blade set comprising a plurality of generally inner blades, an outer blade set comprising a plurality of generally outer blades and a drive mechanism comprising an inner blade mechanism configured to actuate the inner blade set and an outer blade mechanism configured to actuate the outer blade set. As indicated schematically in FIGS. 21, 22A-22B, 24A-24C, 32, 33A-33B, 34A-34C and 35A-35B, the drive mechanism may be configured to be operated in a first direction and a second direction; the drive mechanism may be configured so that (1) when operated in the first direction the inner blade mechanism is actuated and (2) when operated in the second direction the outer blade mechanism is actuated; the drive mechanism may be configured so that when operated in the first direction only the inner blade mechanism is actuated; the drive mechanism may be configured so that when operated in the second direction only the outer blade mechanism is actuated; the drive mechanism may comprise a clutch mechanism configured (1) to engage the inner blade mechanism when operated in the first direction and (2) to engage the outer blade mechanism when operated in the second direction; the clutch mechanism may comprise a one-way bearing; the first direction may be opposite to the second direction. The assembly may comprise a motor configured to operate the drive mechanism; the motor may be configured to operate a shaft to operate the drive mechanism; operation of the drive mechanism in the first direction may comprise rotation of the shaft in the first direction and operation of the drive mechanism in the second direction may comprise rotation of the shaft in the second direction. The inner blade mechanism may comprise a gear and a connecting rod coupled to the inner blade set. The inner blade mechanism may comprise a rack and pinion. The outer blade mechanism may comprise a cam and a follower coupled to the outer blade set. The cam may comprise a spiral cam. The inner blade set may comprise a vertical blade set comprising a plurality of generally vertical blades, and the outer blade set may comprise a horizontal blade set comprising a plurality of generally horizontal blades. The inner airflow mechanism may comprise a gear and a connecting rod coupled to the inner airflow guide. The inner airflow mechanism may comprise a rack and pinion. The outer airflow mechanism may comprise a cam and a follower coupled to the outer airflow guide.

As indicated schematically in FIGS. 3, 4A-4B, 5A-5B, 24A-24C, 34A-34C and 35A-35B, the inner airflow guide may be configured to direct airflow in a first airflow direction and the outer airflow guide may be configured to direct airflow in a second airflow direction; the inner airflow guide may be configured to direct airflow in a generally horizontal direction and the outer airflow guide may be configured to direct airflow in a generally vertical direction; the inner airflow guide may comprise an inner blade set comprising a plurality of vanes, and the outer airflow guide may comprise an outer blade set comprising a plurality of vanes; the inner blade set may comprise a vertical blade set comprising a plurality of generally vertical vanes, and the outer vanes set may comprise a horizontal blade set comprising a plurality of generally horizontal vanes.

According to an exemplary embodiment as shown schematically in FIGS. 1B-1C, 2, 3, 4A-4B, 5A-5B, 6, 21, 22A-22B, 23, 24A-24C, 25A-25B, 32, 33A-33B, 34A-34C and 35A-35B, an air vent assembly/system is provided for a vehicle interior; the air vent system may comprise a vertical blade set comprising a plurality of generally vertical blades, a horizontal blade set comprising a plurality of generally horizontal blades and a drive mechanism comprising a vertical blade mechanism configured to actuate the vertical blade set and a horizontal blade mechanism configured to actuate the horizontal blade set. As indicated schematically in FIGS. 21, 22A-22B, 24A-24C, 32, 33A-33B, 34A-34C and 35A-35B, the drive mechanism may be configured to be operated in a first direction and a second direction; the drive mechanism may be configured so that (1) when operated in the first direction the vertical blade mechanism is actuated and (2) when operated in the second direction the horizontal blade mechanism is actuated; the drive mechanism may be configured so that when operated in the first direction only the vertical blade mechanism is actuated; the drive mechanism may be configured so that when operated in the second direction only the horizontal blade mechanism is actuated; the drive mechanism may comprise a clutch mechanism configured (1) to engage the vertical blade mechanism when operated in the first direction and (2) to engage the horizontal blade mechanism when operated in the second direction; the clutch mechanism may comprise a one-way bearing; the first direction may be opposite to the second direction; the assembly may comprise a motor configured to operate the drive mechanism; the motor may be configured to operate a shaft to operate the drive mechanism; operation of the drive mechanism in the first direction may comprise rotation of the shaft in the first direction and operation of the drive mechanism in the second direction may comprise rotation of the shaft in the second direction. As shown schematically in FIGS. 2, 4A-4B, 5A-5B and 6, the vertical blade mechanism may comprise a gear and a connecting rod coupled to the vertical blade set; the vertical blade mechanism may comprise a rack and pinion; the horizontal blade mechanism may comprise a cam and a follower coupled to the horizontal blade set; the cam may comprise a spiral cam. See FIGS. 25A-25B.

### Exemplary Embodiments—C

According to an exemplary embodiment, an air vent assembly/system may be configured to regulate the ambient temperature inside a vehicle; an air-conditioning outlet is typically arranged on the dashboard or the console of the vehicle; airflow guidance/movement in the vertical and horizontal directions may be controlled through rows of vanes/blades arranged in front (outer) and back (inner). See FIGS. 2 and 3. In a conventional arrangement, a set of two motors may be employed to implement electric regulation in each direction in a convention air vent system. According to an exemplary embodiment as shown schematically in FIGS. 2, 3, 4A-4B, 5A-5B, 6 and 35A-35B, an improved air vent assembly/system providing an air outlet in a vehicle may comprise inner airflow guide/blades and outer airflow guide/blades controlled through a single motor.

According to an exemplary embodiment as shown schematically in FIGS. 1B-1C, 2, 3, 4A-4B, 5A-5B, 6, 21, 22A-22B, 23, 24A-24C, 25A-25B, 32, 33A-33B, 34A-34C and 35A-35B, an air vent assembly/system may comprise: a motor comprising an output shaft; a first one-way bearing and a second one-way bearing, both of which are coupled to the motor; an inner air guiding device coupled to the first one-way bearing; and an outer air guiding device coupled to the second one-way bearing; by means of the forward and reverse rotation of the output shaft, the motor is capable of driving the inner air guiding device through the first one-way bearing, and driving the outer air guiding device to switch between two states through the second one-way bearing. A one-way bearing may be free to rotate in one direction and locked in the other direction (one-way bearings are also known as overrunning clutches). The first one-way bearing and the second one-way bearing may be directly or indirectly connected to the motor. The inner air guiding device is an air guiding device that is close to an inner side of the air outlet, and the outer air guiding device is an air guiding device that is close to an outer side of the air outlet. The outer air guiding device is closer to the space in the vehicle than the inner air guiding device. One of the inner and outer air guiding devices can vertically control the direction of airflow, and the other can horizontally control the direction of airflow.

According to an exemplary embodiment as shown schematically in FIGS. 1B-1C, 2, 3, 4A-4B, 5A-5B, 6, 21, 22A-22B, 23, 24A-24C, 25A-25B, 32, 33A-33B, 34A-34C and 35A-35B, the inner air guiding device may be an inner blade, for example, a vertical blade, to horizontally control the direction of airflow; the outer air guiding device may be an outer blade, for example, a horizontal blade, to vertically control the direction of airflow; the inner air guiding device may be a horizontal blade, and the outer air guiding device may be a vertical blade. The inner air guiding device may be directly or indirectly connected to the first one-way bearing. The outer air guiding device may be directly or indirectly connected to the second one-way bearing. The output shaft of the motor may rotate in forward and reverse directions, for example, in clockwise and counterclockwise directions. When the output shaft of the motor rotates in one direction, the inner air guiding device may be driven to rotate through the first one-way bearing, and when the output shaft of the motor rotates in the other direction, the outer air guiding device may be driven to rotate through the second one-way bearing. As indicated schematically, in the air outlet, a single motor may be used to drive the inner air guiding device and the outer air guiding device to reciprocate when the output shaft rotates forward and reversely, respectively, so that regulation of airflow in two directions is achieved while lowering the costs and reducing mechanical input.

According to an exemplary embodiment as shown schematically in FIGS. 1B-1C, 2, 3, 4A-4B, 5A-5B, 6, 21, 22A-22B, 23, 24A-24C, 25A-25B, 32, 33A-33B, 34A-34C and 35A-35B, the first one-way bearing may comprise a first inner ring and a first outer ring, and the second one-way bearing may comprise a second inner ring and a second outer ring, the first outer ring and the second outer ring having opposite directions of unidirectional rotation. The outer ring of the one-way bearing may rotate in one direction and be locked in the other direction relative to its inner ring, that is, when the inner ring of the one-way bearing rotates in one direction, its outer ring rotates therewith, and when the inner ring of the one-way bearing rotates in the other direction, its outer ring does not rotate. The direction of unidirectional rotation of the first one-way bearing may be opposite to that of the second one-way bearing; when the motor is coupled to the inner rings of the first and second one-way bearings and drives the inner rings to rotate in one direction, the outer ring of one of the first and second one-way bearings rotates with the inner wings, while the outer ring of the other of the first and second one-way bearings does not rotate; when the motor is coupled to the outer rings of the first and second one-way bearings and drives the outer rings to rotate in one direction, the inner ring of one of the first and second one-way bearings rotates with the outer rings, while the inner ring of the other of the first and second one-way bearings does not rotate. See FIGS. 21, 22A-22B, 24A-24C, 32, 33A-33B, 34A-34C and 35A-35B.

According to an exemplary embodiment as shown schematically in FIGS. 1B-1C, 2, 3, 4A-4B, 5A-5B, 6, 21, 22A-22B, 23, 24A-24C, 25A-25B, 32, 33A-33B, 34A-34C and 35A-35B, the first one-way bearing and the second one-way bearing are stacked on each other. The first one-way bearing may be arranged above or below the second one-way bearing. The first one-way bearing and the second one-way bearing may have the same specification and size. The first one-way bearing may be aligned with the second one-way bearing, that is, the central axes of the two bearings may be collinear. By stacking the first one-way bearing and the second one-way bearing, the structure can be simplified, the space can be saved, and the coupling of the motor to the first one-way bearing and the second one-way bearing is facilitated.

According to an exemplary embodiment as shown schematically in FIGS. 1B-1C, 2, 3, 4A-4B, 5A-5B, 6, 21, 22A-22B, 23, 24A-24C, 25A-25B, 32, 33A-33B, 34A-34C and 35A-35B, the output shaft may be sleeved in the first inner ring and the second inner ring, the inner air guiding device may be coupled to the first outer ring, and the outer air guiding device may be coupled to the second outer ring. By sleeving the output shaft of the motor in the first inner ring of the first one-way bearing and the second inner ring of the second one-way bearing, the structure can be simplified, and the space can be saved; as the inner air guiding device is coupled to the first outer ring of the first one-way bearing, and the outer air guiding device is coupled to the second outer ring of the second one-way bearing.

As shown schematically in FIGS. 32, 33A-33B, 34A-34C and 35A (operation of clutch mechanism/one-way bearing with motor shaft rotation in first direction to actuate inner airflow mechanism/guide), the outer air guiding device will not be driven when the motor drives the inner air guiding device through the first one-way bearing. As shown schematically in FIGS. 21, 22A-22B, 23, 24A-24C, 25A-25B and 35B (operation of clutch mechanism/one-way bearing with motor shaft rotation in second direction to actuate outer airflow mechanism/guide), the inner air guiding device will not be driven when the motor drives the outer air guiding device through the second one-way bearing.

According to an exemplary embodiment as shown schematically in FIGS. 1B-1C, 2, 3, 4A-4B, 5A-5B, 6, 21, 22A-22B, 23, 24A-24C, 25A-25B, 32, 33A-33B, 34A-34C and 35A-35B, the output shaft serves as the first inner ring and the second inner ring. By using the output shaft as the first inner ring and the second inner ring, additional first inner ring and second inner ring can be omitted, and the structure is further simplified.

According to an exemplary embodiment as shown schematically in FIGURES, the air outlet may comprise an inner air guiding device transmission mechanism and an outer air guiding device transmission mechanism, the inner air guiding device being coupled to the first outer ring through the inner air guiding device transmission mechanism, and the outer air guiding device being coupled to the second outer ring through the outer air guiding device transmission mechanism. By providing the inner air guiding device transmission mechanism and the outer air guiding device transmission mechanism, the inner air guiding device can be coupled to the first outer ring, and the outer air guiding device can be coupled to the second outer ring.

According to an exemplary embodiment as shown schematically in FIGS. 1B-1C, 2, 3, 4A-4B, 5A-5B, 6, 21, 22A-22B, 23, 24A-24C, 25A-25B, 32, 33A-33B, 34A-34C and 35A-35B, the inner air guiding device transmission mechanism may comprise an inner air guiding device connecting rod coupled to a pivot shaft of the inner air guiding device. By providing the inner air guiding device connecting rod, the inner air guiding device can rotate around its pivot shaft along with the movement of the inner air guiding device connecting rod. The inner air guiding device may comprise a plurality of air guiding devices, and in this case, the plurality of air guiding devices can simultaneously rotate around their respective pivot shafts along with the movement of the inner air guiding device connecting rod. The inner air guiding device connecting rod may be directly or indirectly connected to the first outer ring of the first one-way bearing so as to be actuated by the first one-way bearing.

According to an exemplary embodiment as shown schematically in FIGS. 1B-1C, 2, 3, 4A-4B, 5A-5B, 6, 21, 22A-22B, 23, 24A-24C, 25A-25B, 32, 33A-33B, 34A-34C and 35A-35B, the inner air guiding device transmission mechanism may comprise a connecting rod, one end of the connecting rod being coupled to the inner air guiding device and the other end of the connecting rod being coupled to the first outer ring. According to an exemplary embodiment as shown schematically in the FIGURES, one end of the connecting rod may be provided with a first connecting rod rotating shaft, and the other end of the connecting rod may be provided with a second connecting rod rotating shaft. The connecting rod may be connected to the inner air guiding device connecting rod through the first connecting rod rotating shaft and coupled to the first outer ring through the second connecting rod rotating shaft. By providing the connecting rod, the rotation of the first outer ring of the first one-way bearing can be converted into the translational movement of the inner air guiding device connecting rod.

According to an exemplary embodiment as shown schematically in FIGS. 1B-1C, 2, 3, 4A-4B, 5A-5B, 6, 21, 22A-22B, 23, 24A-24C, 25A-25B, 32, 33A-33B, 34A-34C and 35A-35B, the inner air guiding device transmission mechanism may comprise a gear set; one gear of the gear set may be arranged outside the first outer ring, and the other end of the connecting rod may be eccentrically connected to the other gear of the gear set. According to an exemplary embodiment as shown schematically in the FIGURES, the connecting rod may be eccentrically connected to the other gear of the gear set through the second connecting rod rotating shaft. By providing the gear set, the gear ratio can be adjusted, which is favorable to the adjustment of the rotation of the inner air guiding device. According to an exemplary embodiment as shown schematically in the FIGURES, the outer air guiding device transmission mechanism may comprise an outer air guiding device connecting rod coupled to a pivot shaft of the outer air guiding device. By providing the outer air guiding device connecting rod, the outer air guiding device can rotate around its pivot shaft along with the movement of the outer air guiding device connecting rod. The outer air guiding device may comprise a plurality of air guiding devices, and in this case, the plurality of air guiding devices can simultaneously rotate around their respective pivot shafts along with the movement of the outer air guiding device connecting rod. The outer air guiding device connecting rod may be directly or indirectly connected to the second outer ring of the second one-way bearing so as to be actuated by the second one-way bearing.

According to an exemplary embodiment as shown schematically in FIGS. 1B-1C, 2, 3, 4A-4B, 5A-5B, 6, 21, 22A-22B, 23, 24A-24C, 25A-25B, 32, 33A-33B, 34A-34C and 35A-35B, the outer air guiding device transmission mechanism may comprise a transmission rod, one end of the transmission rod being coupled to the outer air guiding device and the other end being coupled to the outer ring. According to an exemplary embodiment as shown schematically in the FIGURES, one end of the transmission rod may be provided with a connecting rod protrusion, and the outer air guiding device connecting rod may comprise a sliding groove, in which the connecting rod protrusion is fit for sliding. The transmission rod may be provided with a transmission rod rotating shaft. The transmission rod may be rotatable around the transmission rod rotating shaft. By providing the transmission rod, the translational movement of the outer air guiding device connecting rod is achieved along with the rotation of the transmission rod around the transmission rod rotating shaft and the sliding of the connecting rod protrusion in the sliding groove. According to an exemplary embodiment as shown schematically in the FIGURES, the transmission rod may be provided with a track groove protrusion, and outside the second outer ring may be provided with a track groove, in which the track groove protrusion is fit for moving. According to an exemplary embodiment as shown schematically in the FIGURES, the track groove protrusion may be located between the transmission rod rotating shaft and the connecting rod protrusion. By the matching of the track groove protrusion arranged on the transmission rod and the track groove arranged outside the second outer ring, the track groove protrusion moves in the vertical direction along with the rotation of the second outer ring, which drives the transmission rod to rotate around the transmission rod rotating shaft, thereby achieving the translational movement of the outer air guiding device connecting rod and the rotation of the outer air guiding device around its pivot shaft.

According to an exemplary embodiment as shown schematically in FIGS. 2, 3, 4A-4B, 5A-5B, 6, 21, 22A-22B, 23, 24A-24C, 25A-25B, 32, 33A-33B, 34A-34C and 35A-35B, the air outlet may comprise a housing provided inside with the inner air guiding device and the outer air guiding device. The housing provided can be useful for forming flow channels in the inner air guiding device and the outer air guiding device and can also protect the inner air guiding device and the outer air guiding device from inappropriate operation caused by direct contact made by a user with the inner air guiding device and the outer air guiding device. According to an exemplary embodiment as indicated schematically in the FIGURES, the inner air guiding device may comprise a blade, a roller or a moving block, and the outer air guiding device may comprise a blade, a roller or a moving block. The inner air guiding device may comprise a blade, a roller or a moving block, and the outer air guiding device may comprise a blade, a roller or a moving block. The inner and outer air guiding devices may be combined at will. For example, the inner and outer air guiding devices may be a combination of blades, a combination of a blade and a roller, or a combination of a moving block and a blade. According to an exemplary embodiment as shown schematically in the FIGURES, the outer air guiding device may comprise a set of outer blades comprising two outer blades arranged in parallel, and each of the outer blades may comprise two blades hinged to each other. Airflow can flow through a flow channel formed between two outer air guiding devices; because each of the outer air guiding devices may comprise two blades hinged to each other, flow channels with different orientations can be formed by rotating one of the blades, so that airflow in different directions are obtained; by configuration of the outer air guiding devices, the size of the air outlet can be reduced, and the space occupied by the air outlet on the dashboard of a vehicle is saved. See FIGS. 2, 3, 4A-4B, 5A-5B, 6, 21, 22A-22B, 23, 24A-24C, 25A-25B, 32, 33A-33B, 34A-34C and 35A-35B.

According to an exemplary embodiment as shown schematically in FIGS. 1B-1C, 2, 3, 4A-4B, 5A-5B, 6, 21, 22A-22B, 23, 24A-24C, 25A-25B, 32, 33A-33B, 34A-34C and 35A-35B, a single motor may be used to drive the inner and outer air guiding device to reciprocate when the motor rotates forward and backward so that regulation of airflow in two directions is achieved while lowering the costs and reducing mechanical input. According to an exemplary embodiment as shown schematically in the FIGURES, an air outlet may comprise a motor comprising an output shaft, a first one-way bearing and a second one-way bearing, both being coupled to the motor, an inner air guiding device coupled to the first one-way bearing and an outer air guiding device coupled to the second one-way bearing. By means of forward and reverse rotation of the output shaft, the motor is capable of driving the inner air guiding device through the first one-way bearing and driving the outer air guiding device to switch between two states through the second one-way bearing. The first one-way bearing may comprise a first inner ring and a first outer ring, and the second one-way bearing may comprise a second inner ring and a second outer ring; the first outer ring and the second outer ring may have opposite directions of unidirectional rotation. The first one-way bearing and the second one-way bearing may be stacked on each other. The output shaft may be sleeved in the first inner ring and the second inner ring; the inner air guiding device may be coupled to the first outer ring, and the outer air guiding device may be coupled to the second outer ring. The output shaft may serve as the first inner ring and the second inner ring. The air outlet may comprise an inner air guiding device transmission mechanism and an outer air guiding device transmission mechanism, the inner air guiding device may be coupled to the first outer ring through the inner air guiding device transmission mechanism, and the outer air guiding device may be coupled to the second outer ring through the outer air guiding device transmission mechanism. The inner air guiding device transmission mechanism may comprise a connecting rod, one end of the connecting rod may be coupled to the inner air guiding device and the other end of the connecting rod may be coupled to the first outer ring. The inner air guiding device transmission mechanism may comprise a gear set, one gear of the gear set may be arranged outside the first outer ring, and the other end of the connecting rod may be eccentrically connected to the other gear of the gear set. The outer air guiding device transmission mechanism may comprise a transmission rod, one end of the transmission rod may be coupled to the outer air guiding device and the other end may be coupled to the second outer ring. The transmission rod may be provided with a track groove protrusion, and outside the second outer ring may be provided with a track groove, the track groove protrusion may be fit for moving in the track groove. The inner air guiding device may be a blade, a roller or a moving block, and the outer air guiding device may be a blade, a roller or a moving block. The outer air guiding device may be a set of outer blades comprising two outer blades arranged in parallel, and each of the outer blades may comprise two blades hinged to each other.

REFERENCE SYMBOL LIST

| | REFERENCE |
|---|---|
| ELEMENT, PART OR COMPONENT | SYMBOL |
| vehicle | V |
| interior | I |
| component | C |
| instrument panel | IP |
| door panel | DP |
| floor console | FC |
| air vent system/assembly | AV |
| user interface | UI |
| operator control | OC |
| drive mechanism | DM |
| clutch mechanism/assembly | CM |
| motor | M |
| airflow guide mechanism - inner/vertical | VM |
| airflow guide mechanism - outer/horizontal | HM |
| airflow guides/vanes - inner/vertical blade set | VB |
| airflow guides/vanes - outer/horizontal blade set | HB |
| airflow | AF |
| housing | 1 |
| motor | 2 |
| output shaft | 22 |
| first one-way bearing/clutch | 31 |
| second one-way bearing/clutch | 32 |
| transmission rod/driving rod | 42 |
| outer blade connecting rod | 43 |
| outer blades/horizontal guide | 44 |
| transmission gear | 51 |
| connecting rod | 52 |
| inner blade connecting rod | 53 |
| inner blades/vertical guide | 54 |
| gear | 311 |
| first outer ring | 312 |
| first wedges | 313 |
| track groove | 321 |
| second wedges | 322 |
| inner wall (of second outer ring of second | 323 |
| one-way bearing) | |
| upper ring component | 324 |
| lower ring component | 325 |
| track groove protrusion | 421 |
| transmission rod rotating shaft | 422 |
| connecting rod protrusion | 423 |
| sliding groove | 431 |
| second connecting rod rotating shaft | 521 |
| first connecting rod rotating shaft | 522 |

It is important to note that the present inventions (e.g. inventive concepts, etc.) have been described in the specification and/or illustrated in the FIGURES of the present patent document according to exemplary embodiments; the embodiments of the present inventions are presented by way of example only and are not intended as a limitation on the scope of the present inventions. The construction and/or arrangement of the elements of the inventive concepts embodied in the present inventions as described in the specification and/or illustrated in the FIGURES is illustrative only. Although exemplary embodiments of the present inventions have been described in detail in the present patent document, a person of ordinary skill in the art will readily appreciate that equivalents, modifications, variations, etc. of the subject matter of the exemplary embodiments and alternative embodiments are possible and contemplated as being within the scope of the present inventions; all such subject matter (e.g. modifications, variations, embodiments, combinations, equivalents, etc.) is intended to be included within the scope of the present inventions. It should also be noted that various/other modifications, variations, substitutions, equivalents, changes, omissions, etc. may be made in the configuration and/or arrangement of the exemplary embodiments (e.g. in concept, design, structure, apparatus, form, assembly, construction, means, function, system, process/method, steps, sequence of process/method steps, operation, operating conditions, performance, materials, composition, combination, etc.) without departing from the scope of the present inventions; all such subject matter (e.g. modifications, variations, embodiments, combinations, equivalents, etc.) is intended to be included within the scope of the present inventions. The scope of the present inventions is not intended to be limited to the subject matter (e.g. details, structure, functions, materials, acts, steps, sequence, system, result, etc.) described in the specification and/or illustrated in the FIGURES of the present patent document. It is contemplated that the claims of the present patent document will be construed properly to cover the complete scope of the subject matter of the present inventions (e.g. including any and all such modifications, variations, embodiments, combinations, equivalents, etc.); it is to be understood that the terminology used in the present patent document is for the purpose of providing a description of the subject matter of the exemplary embodiments rather than as a limitation on the scope of the present inventions.

It is also important to note that according to exemplary embodiments the present inventions may comprise conventional technology (e.g. as implemented and/or integrated in exemplary embodiments, modifications, variations, combinations, equivalents, etc.) or may comprise any other applicable technology (present and/or future) with suitability and/or capability to perform the functions and processes/operations described in the specification and/or illustrated in the FIGURES. All such technology (e.g. as implemented in embodiments, modifications, variations, combinations, equivalents, etc.) is considered to be within the scope of the present inventions of the present patent document.

The invention claimed is:

1. An air vent assembly configured for a vehicle interior comprising:
(a) an inner airflow guide;
(b) an outer airflow guide;
(c) a drive mechanism comprising an inner airflow mechanism configured to actuate the inner airflow guide and an outer airflow mechanism configured to actuate the outer airflow guide;
wherein the drive mechanism is configured to be operated in a first direction and a second direction;
wherein the drive mechanism is configured so that (1) when operated in the first direction the inner airflow mechanism is actuated and (2) when operated in the second direction the outer airflow mechanism is actuated.

2. The assembly of claim 1 wherein the drive mechanism is configured so that when operated in the first direction only the inner airflow mechanism for the inner airflow guide is actuated.

3. The assembly of claim 1 wherein the drive mechanism is configured so that when operated in the second direction only the outer airflow mechanism for the outer airflow guide is actuated.

4. The assembly of claim 1 wherein the drive mechanism comprises a clutch mechanism configured (1) to engage the inner airflow mechanism when operated in the first direction and (2) to engage the outer airflow mechanism when operated in the second direction.

5. The assembly of claim 4 wherein the clutch mechanism comprises a set of one-way bearings.

6. The assembly of claim 5 wherein the set of one-way bearings comprises a one-way bearing for the inner airflow mechanism and a one-way bearing for the outer airflow mechanism.

7. The assembly of claim 1 further comprising a motor configured to operate the drive mechanism; wherein the motor is configured to operate a shaft to operate the drive mechanism.

8. The assembly of claim 7 wherein operation of the drive mechanism in the first direction comprises rotation of the shaft in the first direction and operation of the drive mechanism in the second direction comprises rotation of the shaft in the second direction.

9. The assembly of claim 8 wherein the first direction is opposite to the second direction.

10. The assembly of claim 1 wherein the inner airflow mechanism comprises a gear and a connecting rod coupled to the inner airflow guide.

11. The assembly of claim 1 wherein the outer airflow mechanism comprises a cam and a follower coupled to the outer airflow guide.

12. The assembly of claim 1 wherein the inner airflow guide is configured to direct airflow in a first airflow direction and the outer airflow guide is configured to direct airflow in a second airflow direction.

13. The assembly of claim 1 wherein the inner airflow guide comprises an inner blade set comprising a plurality of blades; and wherein the outer airflow guide comprises an outer blade set comprising a plurality of blades.

14. The assembly of claim 13 wherein the inner blade set comprises a vertical blade set comprising a plurality of generally vertical blades; and wherein the outer blade set comprises a horizontal blade set comprising a plurality of generally horizontal blades.

15. An air vent assembly configured for a vehicle interior comprising:
(a) an inner blade set comprising a plurality of blades;
(b) an outer blade set comprising a plurality of blades;
(c) a drive mechanism configured to be operated in a first direction and a second direction;
wherein the drive mechanism comprises an inner blade mechanism configured to actuate the inner blade set;
wherein the drive mechanism comprises an outer blade mechanism configured to actuate the outer blade set;
wherein the drive mechanism comprises a clutch assembly configured so that (1) when the drive mechanism is operated in the first direction the inner blade mechanism is actuated and (2) when the drive mechanism is operated in the second direction the outer blade mechanism is actuated.

16. The assembly of claim 15 wherein the clutch assembly is configured so that (1) when the drive mechanism is operated in the first direction a clutch is engaged to actuate the inner blade mechanism and (2) when the drive mechanism is operated in the second direction a clutch is engaged to actuate the outer blade mechanism.

17. The assembly of claim 15 further comprising a motor configured to operate the drive mechanism through a transmission in the first direction and in the second direction; wherein the first direction is opposite to the second direction.

18. An air vent system configured for a vehicle interior comprising:
(a) a vertical blade set comprising a plurality of generally vertical blades;
(b) a horizontal blade set comprising a plurality of generally horizontal blades;
(c) a drive mechanism configured to be operated in a first direction and a second direction; and
(d) a motor configured to operate the drive mechanism through a transmission in the first direction and in the second direction;
wherein the drive mechanism comprises a vertical blade mechanism configured to actuate the vertical blade set;
wherein the drive mechanism comprises a horizontal blade mechanism configured to actuate the horizontal blade set;
wherein the drive mechanism is configured so that (1) when operated in the first direction only the vertical blade mechanism is actuated and (2) when operated in the second direction only the horizontal blade mechanism is actuated.

19. The system of claim 18 wherein the drive mechanism comprises a clutch assembly configured so that (1) when the drive mechanism is operated in the first direction the vertical blade mechanism is actuated through a clutch for the first direction and (2) when the drive mechanism is operated in the second direction the horizontal blade mechanism is actuated through a clutch for the second direction.

20. The system of claim 19 wherein the clutch assembly is configured so that (1) when the drive mechanism is operated in the first direction the clutch for the first direction is engaged so that only the vertical blade mechanism is actuated to move the vertical blade set and the clutch for the second direction is disengaged; and (2) when the drive mechanism is operated in the second direction the clutch for the second direction is engaged so that only the horizontal blade mechanism is actuated to move the horizontal blade set and the clutch for the first direction is disengaged.
